(19) United States
(12) Patent Application Publication
(10) Pub. No.: US 2013/0030066 A1
(43) Pub. Date: Jan. 31, 2013

(54) POLYMERIC FLAME RETARDANT

(71) Applicants: Klaus Hahn, Kirchheim (DE); Sabine Fuchs, Mannheim (DE); Ingo Bellin, Mannheim (DE); Patrick Spies, Neustadt (DE); Maximilian Hofmann, Island South (CN); Peter Deglmann, Mannheim (DE); Klemens Massonne, Bad Durkheim (DE); Hartmut Denecke, Ludwigshafen (DE); Christoph Fleckenstein, Freigericht (DE); Geert Janssens, Friedelsheim (DE); Anna Müller-Cristadoro, Waldems (DE); Bernd Bruchmann, Freinsheim (DE)

(72) Inventors: Klaus Hahn, Kirchheim (DE); Sabine Fuchs, Mannheim (DE); Ingo Bellin, Mannheim (DE); Patrick Spies, Neustadt (DE); Maximilian Hofmann, Island South (CN); Peter Deglmann, Mannheim (DE); Klemens Massonne, Bad Durkheim (DE); Hartmut Denecke, Ludwigshafen (DE); Christoph Fleckenstein, Freigericht (DE); Geert Janssens, Friedelsheim (DE); Anna Müller-Cristadoro, Waldems (DE); Bernd Bruchmann, Freinsheim (DE)

(73) Assignee: BASF SE, Ludwigshafen (DE)

(21) Appl. No.: 13/559,786

(22) Filed: Jul. 27, 2012

Related U.S. Application Data
(60) Provisional application No. 61/512,957, filed on Jul. 29, 2011.

(51) Int. Cl. C08K 5/523; B29B 9/12; C07F 9/12; C08J 9/04; C08L 25/06

(52) U.S. Cl. 521/79; 524/141; 521/85; 521/146; 558/186; 558/99; 264/5

(57) ABSTRACT

The invention relates to a polymer composition containing
i) styrene polymer(s) and
ii) phosphorylated polyether(s) with from 0.5 to 40% by weight phosphorus content, the main chain of which is formed exclusively from carbon atoms and from oxygen atoms, and which has at least three terminal and/or pendant OH groups, where these have been substituted with

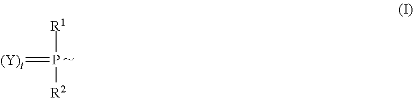

where
˜ indicates the bond to the polymer skeleton of the polyether;
Y is O or S;
t is 0 or 1;
R¹ and R², being identical or different, are H, C₁-C₁₈-alkyl, C₂-C₁₈-alkenyl, C₂-C₁₈-alkynyl, C₃-C₁₀-cycloalkyl, C₆-C₁₀-aryl, furyl, C₆-C₁₀-aryl-C₁-C₁₀-alkyl, OR³, SR³, NR³R⁴, COR³, COOR³ or CONR³R⁴, or R¹ and R² form, together with the phosphorus atom P, a 4-8-membered ring system;
R³ and R⁴, being identical or different, are H, C₁-C₁₆-alkyl, C₂-C₁₆-alkenyl, C₃C₁₆-alkynyl, C₃-C₁₀-cycloalkyl, C₆-C₁₀-aryl or C₆-C₁₀-aryl-C₁-C₁₀-alkyl,
   and/or
polycarbonates containing phosphorus-containing group(s) of the general formula (I).

The invention relates to phosphorus-containing polymers, processes for producing these, to the use of these as flame retardants, and also to plastics, in particular foams, which comprise said flame retardants.

The materials currently mainly used as flame retardants in plastics are polyhalogenated hydrocarbons, optionally in combination with suitable synergists, for example organic peroxides or nitrogen-containing compounds. A typical representative of said traditional flame retardants is hexabromocyclododecane (HBCD), which is used by way of example in polystyrene. Bioaccumulation, and also the persistence of some polyhalogenated hydrocarbons, have led to major attempts to replace halogenated flame retardants within the plastics industry.

Flame retardants should as far as possible not only have a high level of flame-retardant effect at a low level of loading within the plastic but should also have the levels of heat-resistance and hydrolysis resistance that are required for processing. They should also exhibit no bioaccumulation or persistence.

WO 2000/34367 describes a process for producing halogen-free flame-retardant extruded polystyrene foams (XPS) in the presence of from 2 to 12% by weight of expandable graphite and optionally from 1 to 12% by weight of a phosphorus compound (e.g. red phosphorus and/or triphenyl phosphate) as flame retardant.

WO 2006/027241 discloses the use of 9,10-dihydro-9-oxa-10-phosphaphenanthrene 10 oxide (DOPO) and derivatives thereof for producing polymer foams with halogen-free flame retardancy.

WO 2009/035881 and WO 2008/088487 describe halogen-free flame retardants using sulfur-phosphorus compounds, in particular thiophosphates and thiophosphonates, and use of these in compact polystyrene and in polystyrene foams.

EP 0 474 076 A1 describes high branched polyphosphates as flame retardants for polyester (polyalkylene terephthalate).

WO 2007/066383 describes hyperbranched polyesters which were reacted with phosphorus compounds, such as 9,10-dihydro-9-oxa-10-phosphaphenanthrene 10 oxide (DOPO), and also use of these as flame retardants for resins. JP-A 2003-206350 describes aromatic polycarbonates which are in essence linear and in which there are aromatic groups substituted by phosphorus-containing moieties. The compounds serve as flame retardants for resins. WO 2006/084488 and WO 89/01011 describe polymers which are based on tri-2-hydroxyethyl isocyanurate (THEIC) and which have modification by DOPO or polyphosphate groups.

There is nevertheless much room for improvements to flame retardants of this type, for example because the amounts of halogen-free flame retardants that have to be used are generally markedly higher than those of halogen-containing flame retardants, to achieve the same flame-retardant effect. For this reason, halogen-free flame retardants which can be used for thermoplastic polymers, such as polystyrene, often cannot be used for polymer foams because they either disrupt the foaming process or affect the mechanical and thermal properties of the polymer foam. The large amounts of flame retardant can moreover reduce the stability of the suspension during production of expandable polystyrene via suspension polymerization. The effect of the flame retardants used for thermoplastic polymers is moreover often unpredictable in polymer foams, because of the differences in fire behavior and in fire tests.

It is therefore an object of the invention to provide compounds which firstly are halogen free and which secondly, even when amounts used are small, exhibit good flame retardancy properties in polymers, in particular in polymer foams.

Particular phosphorylated polyethers and polycarbonates which have particular suitability for use as flame retardants have been discovered.

The invention therefore provides a polymer composition, in particular a foam, comprising
i) one or more styrene polymers and
ii) one or more phosphorylated polyethers (ii-1) with from 0.5 to 40% by weight phosphorus content, the main chain of which is formed exclusively from carbon atoms and from oxygen atoms, and which has at least three terminal and/or pendant OH groups, where these have been substituted to some extent or entirely with at least one phosphorus-containing group (I),

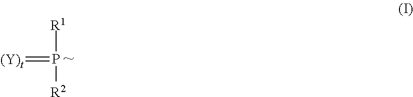

where the definitions of the symbols and indices are as follows:
˜ indicates the bond to the polymer skeleton of the polyether;
Y is O or S;
t is 0 or 1;
R¹ and R², being identical or different, are H, C₁-C₁₈-alkyl, C₂-C₁₈-alkenyl, C₂-C₁₈-alkynyl, C₃-C₁₀-cycloalkyl, C₆-C₁₀-aryl, furyl, C₆-C₁₀-aryl-C₁-C₁₀-alkyl, OR³, SR³, NR³R⁴, COR³, COOR³ or CONR³R⁴, or R¹ and R² form, together with the phosphorus atom P, a 4-8-membered ring system;
R³ and R⁴, being identical or different, are H, C₁-C₁₆-alkyl, C₂-C₁₆-alkenyl, C₂-C₁₆-alkynyl, in particular C₃-C₁₆-alkynyl, C₃-C₁₀-cycloalkyl, C₆-C₁₀-aryl or C₆-C₁₀-aryl-C₁-C₁₀-alkyl,
   where aryl groups in the moieties R¹, R², R³, and R⁴ are unsubstituted or have substitution by from 1 to 3 C₁-C₄-alkyl and/or C₁-C₄-alkoxy groups,
      and/or
      polycarbonates (ii-2) comprising one or more phosphorus-containing groups, where the phosphorus-containing group is preferably a group of the general formula (I).

The invention further provides phosphorylated polyethers (ii-1), a process for producing these, and the use of these as flame retardants.

The polycarbonates and polyethers used in the invention are halogen-free and, even when amounts are small, have excellent effectiveness as flame retardants, in particular in foams.

The polyether (ii-1) used in the invention is novel and is likewise provided by the invention. The polyether of the invention is a high-functionality polyether. An abovementioned high-functionality polyether can be produced via reaction of at least one at least trihydric alcohol and optionally further di- and/or monohydric alcohols and/or modifier reagents. The high-functionality polyether has, alongside the ether groups which form the polymer skeleton, at least three, preferably at least six, particularly preferably at least ten, terminal or pendant OH groups. The skeleton of the polymer here can be linear or branched. There is in principle no upper limit placed upon the number of terminal or pendant functional groups, but products with a very large number of functional groups can have undesired properties, for example high viscosity or poor solubility. The high-functionality polyethers used for the purposes of the invention mostly have no more than 1000 terminal or pendant functional OH groups, preferably no more than 500, with particular preference no more than 100 terminal or pendant functional OH groups. It is preferable that the high-functionality polyether to be used in the invention is the condensate from an average of at least 3, particularly preferably at least 4, more preferably at least 5, and in particular at least 6, di- or at least trihydric alcohols. It is further preferable here that it is the condensate from an average of at least 3, particularly preferably at least 4, specifically at least 5, and in particular at least 6, at least trihydric alcohols.

In one preferred embodiment, the polyethers of the invention are hyperbranched polyethers. For the purposes of this invention, hyperbranched polyethers are uncrosslinked polymer molecules having hydroxy groups and ether groups, where the degree of branching of these (DB), i.e. the average number of dendritic linkages plus the average number of terminal groups per molecule divided by the sum of the average number of dendritic, linear, and terminal linkages and multiplied by 100 is from 10 to 99.9%, preferably from 20 to 99%, particularly preferably from 20 to 95%. In the context of the invention, “dendrimer” means that the degree of branching is from 99.9 to 100%. For the definition of “Degree of Branching”, see H. Frey et al., Acta Polym. 1997, 48, 30.

The hyperbranched polyethers of the invention have both structural and molecular nonuniformity. On the one hand, they can have structures based on a central molecule by analogy with dendrimers, but with nonuniform chain length of the branches. On the other hand, they can also have linear regions having functional pendant groups. For the definition of dendrimers and of hyperbranched polymers, see also P. J. Flory, J. Am. Chem. Soc. 1952, 74, 2718 and H. Frey et al., Chem. Eur. J. 2000, 6, 15 No. 14, 2499.

Examples of at least trihydric alcohols that can be used are triols, such as trimethylolmethane, trimethylolethane, trimethylolpropane (TMP), and 1,2,4-butanetriol. It is equally possible to use tetrols, such as bistrimethylolpropane (Di-TMP) or pentaerythritol. It is moreover possible to use polyols of higher functionality, for example bispentaerythritol (Di-Penta) or inositols. Other compounds that can also be used are alkoxylation products of the abovementioned alcohols, and also of glycerol, preferably having from 1 to 40 alkylene oxide units per molecule. Particularly preferred at least trihydric alcohols are aliphatic alcohols and in particular those having primary hydroxy groups, e.g. trimethylolmethane, trimethylolethane, trimethylolpropane, Di-TMP, pentaerythritol, dipentaerythritol, and alkoxylates of these having from 1 to 30 ethylene oxide units per molecule, and also glycerol ethoxylates having from 1 to 30 ethylene oxide units per molecule. It is very particularly preferable to use trimethylolpropane and pentaerythritol and ethoxylates of these having an average of from 1 to 20 ethylene oxide units per molecule, and also glycerol ethoxylates having from 1 to 20 ethylene oxide units per molecule. It is equally possible to use the abovementioned alcohols in a mixture.

The at least trihydric alcohols can also be used in a mixture with dihydric alcohols. Examples of suitable compounds having two OH groups comprise ethylene glycol, diethylene glycol, triethylene glycol, 1,2- and 1,3-propanediol, dipropylene glycol, tripropylene glycol, neopentyl glycol, 1,2-, 1,3-, and 1,4-butanediol, 1,2-, 1,3-, and 1,5-pentanediol, hexanediol, dodecanediol, cyclopentanediol, cyclohexanediol, cyclohexanedimethanol, bis(4-hydroxycyclohexyl)methane, bis(4-hydroxycyclo-hexyl)ethane, 2,2-bis(4-hydroxycyclohexyl)propane, and dihydric polyether polyols based on ethylene oxide, on propylene oxide, on butylene oxide, or on a mixture of these, or polytetrahydrofuran. It is also possible, of course, to use the dihydric alcohols in mixtures.

The diols serve for fine adjustment of the properties of the polyether. If dihydric alcohols are used, the ratio of dihydric alcohols to the at least trihydric alcohols is established by the person skilled in the art as a function of the desired properties of the polyether. The amount of the dihydric alcohol(s) is generally from 0 to 99 mol %, preferably from 0 to 80 mol %, particularly preferably from 0 to 75 mol %, and very particularly preferably from 0 to 50 mol %, based on the total amount of all of the alcohols. It is also possible to obtain block copolyether polyols for example diol-terminated polyethers, here via alternating addition of at least trihydric alcohols and of diols during the course of the reaction.

It is also possible in the invention to precondense dihydric alcohols to give OH-terminated oligomers and then to add the at least trihydric alcohol. This method can equally be used to obtain hyperbranched polymers having linear block structures.

It is also possible to add monools in order to control OH-functionality during or after the reaction of the at least trihydric alcohols. These monools can by way of example be linear or branched-chain aliphatic or aromatic monools. These preferably have more than 3 carbon atoms, particularly preferably more than 6. Other suitable monools are monohydric polyethers. It is preferable to add at most 50 mol % of monool, based on the total amount of the at least trihydric alcohol.

Polyethers which are very particularly suitable for the purposes of the invention can be obtained via reaction of triethylene glycol and pentaerythritol, preferably from a triethylene glycol/pentaerythritol mixture with a molar ratio in the range from 1:10 to 10:1, particularly preferably from 1:5 to 5:1, still more preferably from 1:2 to 2:1, in particular from 1.5:1 to 1:1.5, most preferably 1:1.

The number-average molar mass of the polyether for the purposes of the invention is preferably in the range from 100 g/mol to 5000 g/mol, in particular in the range from 700 g/mol to 1500 g/mol. Its weight-average molar mass is advantageously in the range from 1000 g/mol to 100 000 g/mol, in particular in the range from 5000 g/mol to 50 000 g/mol.

These molar masses can be determined in a manner known per se, in particular by means of gel permeation chromatography, using appropriate standards.

Further details concerning these high-functionality polyethers and production of the same are described in WO 2009/101141, the disclosure of which is hereby explicitly incorporated by way of reference.

Another preferred embodiment of the invention uses polyether based on glycerol as stabilizing reagent. The production of polyether based on glycerol has likewise been described. By way of example, U.S. Pat. No. 3,932,532 and DE 103 07 172 describe the production of polyethers based on glycerol with catalysis by strong alkalines to give oligomeric polyethers, and WO 2004/074346 also discloses modification of these using monohydric alcohols.

DE 103 07 172 also discloses the polycondensation of glycerol in the presence of acidic catalysts, for example HCl, H₂SO₄, sulfonic acid or H₃PO₄ in the absence of water at temperatures of from 200° C. to 280° C. within the period of from 5 to 15 hours.

EP 141253, DE 4446877, and U.S. Pat. No. 5,728,796 disclose the reaction of at least trihydric alcohols under acidic reaction conditions in the presence of acetone or epoxy compounds. The products obtained are low-molecular-weight, modified alcohols.

WO 2004/074346 discloses the alkaline polycondensation of glycerol and the subsequent reaction of the resultant condensate under acidic conditions with a fatty alcohol. This gives a fatty-alcohol-modified polyglycerol.

DE 199 47 631 and DE 102 11 664 also describe hyperbranched polyglycerol ethers. Here, the production process uses ring-opening reaction of glycidyl, optionally in the presence of a polyfunctional starter molecule.

Another preferred embodiment of the invention uses high-functionality polyethers exclusively based on trimethylolpropane units and/or exclusively based on pentaerythritol units and/or copolymers of these, as stabilizing reagent.

Another method of producing hyperbranched polyethers, as described by way of example in WO 00/56802, uses specific catalysts for ring-opening polymerization of 1-ethyl-1-hydroxymethyloxetane. The polymer skeleton here is composed exclusively of trimethylolpropane units. According to Nishikubo et al., Polymer Journal 2004, 36 (5) 413, it is equally possible to carry out a ring-opening reaction of 3,3-bis(hydroxymethyl)oxetane to give a highly branched polyether composed exclusively of pentaerythritol units.

Chen et. al, J. Poly. Sci. Part A: Polym. Chem. 2002, 40, 1991, describe synthesis in which 1-ethyl-1-hydroxymethyloxetane and 3,3-bis(hydroxymethyl)oxetane are together subjected to a ring-opening polymerization reaction. The product here is a polyether polyol made of a mixture of trimethylolpropane units and pentaerythritol units.

Preferred polycarbonates (ii-2) are high-functionality, highly branched or hyperbranched polycarbonates based on dialkyl or diaryl carbonates or phosgene, diphosgene, or triphosgene, and on aliphatic, aliphatic/aromatic, and aromatic di- or polyols, where the production of these has been described in the European patent application EP 1664154 B1. Preferred polycarbonates are those in which R¹ is the same as R^{2′} and R¹ and R^{2′} are respectively methoxyphenyl, tolyl, furyl, cyclohexyl, phenyl, phenoxy, ethoxy or methoxy. Polycarbonates (ii-2) to which preference is further given are those in which the polycarbonate comprises from 0.5 to 40% by weight of phosphorus, particularly preferably at least 3% by weight.

Polycarbonates (ii-2) to which preference is further given are those which comprise no free OH groups.

Polycarbonates (ii-2) to which preference is further given comprise at least one free OH group.

Polycarbonates (ii-2) to which preference is further given are those in which the polycarbonate has an OH number (determined to DIN 53240) of from 2 to 800 mg KOH/g.

Polycarbonates (ii-2) to which preference is further given comprise propylene oxide units and/or ethylene oxide units.

Polycarbonates (ii-2) to which preference is further given are characterized in that the polycarbonate is a hyperbranched polycarbonate, where the definition of “hyperbranched” is as above for the polyethers of the invention.

Polycarbonates (ii-2) to which preference is further given are those in which the polycarbonate has no aromatic constituents in the carbonate skeleton.

The abovementioned polycarbonates and production of these are described in the international patent application WO 2011/144 726. The description of the polycarbonates (ii-2) in said application is expressly incorporated by quotation herein as constituent of this application by way of reference.

The polycarbonates and/or polyethers used in the invention preferably comprise at least one phosphorus-containing group (I). Preferred definitions of the symbols in the phosphorus-containing group of the formula (I) are as follows:
˜ indicates the bond to the polymer skeleton of the polyether and/or polycarbonate.
Y is preferably O or S.
t is preferably 0 or 1.
R¹ and R², being identical or different, are preferably C₁-C₁₈-alkyl, C₂-C₁₈-alkenyl, C₃-C₁₈-cycloalkyl, C₆-C₁₀-aryl, furyl, OR³;
R³ and R⁴, being identical or different, are preferably C₁-C₁₈-alkyl, C₃-C₁₀-cycloalkyl or C₆-C₁₀-aryl.
Aryl groups in the moieties R¹, R², R³, and R⁴ are preferably unsubstituted or have substitution by from 1 to 3 C₁-C₄-alkyl and/or C₁-C₄-alkoxy groups.

Preference is given to groups (I) in which the definitions of all of the symbols and indices are the preferred definitions.

Particularly preferred definitions of the symbols in the phosphorus-containing group of the formula (I) are:
Y is particularly preferably O.
t is particularly preferably 0 or 1.
R¹ and R² are particularly preferably identical and are C₁-C₆-alkyl, cyclohexyl, phenyl, furyl or OR³.
R³ is particularly preferably C₁-C₆-alkyl, cyclohexyl or phenyl.
Phenyl moieties R¹, R², and R³ are particularly preferably unsubstituted or have substitution by C₁-C₄-alkyl, and/or C₁-C₄-alkyl and/or C₁-C₄-alkoxy.

Particular preference is given to groups (I) in which the definitions of all of the symbols and indices are the particularly preferred definitions.

Definitions to which particular preference is given for the symbols and indices in the formula (I) are as follows:
Y is with particular preference O.
t is with particular preference 1.
R¹ and R² are with particular preference identical and are phenyl, phenoxy, methoxyphenyl, tolyl, furyl, cyclohexyl, methyl, ethyl, methoxy or ethoxy.

Groups of the formula (I) which are in particular preferred are those in which the definitions of all of the symbols and indices are the definitions to which particular preference is given.

Particular preference is further given to the following groups of the formula (I):

(Ph)₂(O)P˜ (1.1)

(PhO)₂(O)P˜ (1.2).

If mixtures of one or more polyethers (ii-1) and of one or more polycarbonates (ii-2) are used, the definitions of the symbols and indices in the formula (I) are mutually independently identical or different.

The reactive phosphorus derivatives of the formula (I-A) which are suitable for synthesizing the phosphorylated polyethers and/or polycarbonates used in the invention

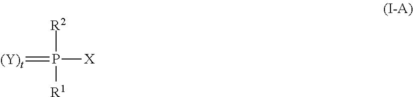

where X is Cl, Br, I, (C₁-C₄)-alkoxy, or H, and the definitions of the other symbols are the definitions stated in the formula (I) are usually available commercially or can be prepared by way of synthesis routes well known in the literature [c.f. Science of Synthesis (former Houben Weyl) 42 (2008); Houben Weyl E1-2 (1982); Houben Weyl 12 (1963-1964)]. Explicit examples that may be mentioned are:
chlorodiphenylphosphine (t=0; R¹═R²=Ph), [c.f. Sun, Dengli; Wang, Chunyu; Gong, Shengming; Sun, Shengwen. CN 101481390 A 20090715];
diphenylphosphinyl chloride (t=1; Y═O; R¹═R²=Ph), [c.f. Caminade, Anne Marie; El Khatib, Fayez; Baceiredo, Antoine; Koenig, Max. Phosphorus and Sulfur and the Related Elements (1987), 29(2-4), 365-7];
diphenylthiophosphinyl chloride (Y═S; R¹═R²=Ph), [c.f. Hodgson, Linda M.; Platel, Rachel H.; White, Andrew J. P.; Williams, Charlotte K. Macromolecules (Washington, D.C., United States) (2008), 41(22), 8603-8607];
diphenyl chlorophosphate (Y═O; R¹═R²═OPh), [c.f. Fadeicheva, A. G.; Rudenko, L. G.; Skuratovskaya, T. N. Metody Polucheniya Khimicheskikh Reaktivov i Preparatov (1969), No. 18 207-9].

Suitable solvents are inert organic solvents, e.g. DMSO, halogenated hydrocarbons, e.g. methylene chloride, chloroform, 1,2-dichloroethane, or chlorobenzene. Solvents with further suitability are ethers, e.g. diethyl ether, methyl tert-butyl ether, dibutyl ether, dioxane, or tetrahydrofuran. Solvents with further suitability are hydrocarbons, e.g. hexane, benzene, or toluene. Solvents with further suitability are nitriles, e.g. acetonitrile or propionitrile. Solvents with further suitability are ketones, e.g. acetone, butanone, or tert-butyl methyl ketone.

It is also possible to use mixtures of the solvents.

Suitable bases are metal hydrides, e.g. sodium hydride, or non-nucleophilic amine bases, e.g. triethylamine, Hünig's base, bicyclic amines, such as 1,8-diazabicyclo[5.4.0]undec-7-ene (DBU), N-methylimidazole, or N-methylmorpholine, N-methylpiperidine, pyridine, and substituted pyridines, such as lutidine. Particular preference is given to triethylamine and N-methylimidazole.

The amounts used of the bases are generally equimolar. However, they can also be used in excess or, if appropriate, as solvents.

The amounts reacted of the starting materials are generally stoichiometric in a ratio of 1:2 (OM groups: chlorophosphorus component). It can be advantageous to use the chlorophosphorus component in an excess in relation to the hydroxy functionalities of the polyether. Use of a substoichiometric amount of the chlorophosphorus component can achieve random partial phosphorylation.

The heteroatom can, as described, be introduced directly via coupling of the respective chlorophosphorus component. A second possibility is the coupling of a trivalent phosphorus species to the hydroxy functionality and subsequent oxidation to introduce the heteroelement by using oxidizing or sulfidizing reagents [cf. Grachev, M. K.; Anfilov, K. L.; Bekker, A. K.; Nifant'ev. E. E. Zhurnal Obshchei Khimii (1995), 65(12), 1946-50].

The reactions are usually carried out at temperatures of from 0° C. to the boiling point of the reaction mixture, preferably from 0° C. to 110° C., particularly preferably from room temperature to 110° C.

The reaction mixtures are worked up conventionally, e.g. via filtration, mixing with water, separation of the phases and optionally chromatographic purification of the crude products. Some of the products occur in the form of highly viscous oils, which are freed from volatile content or purified at reduced pressure and slightly elevated temperature. If the products are obtained in the form of solids, they can also be purified by recrystallization or digestion.

The invention further provides a process for producing a phosphorylated polyether (ii-1) of the invention, comprising the reaction of a polyether, the main chain of which is formed exclusively from carbon and oxygen atoms, and which comprises at least three terminal and/or pendant OH groups, with a phosphorus compound (I-A),

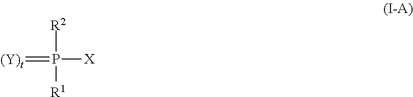

where X is Cl, Br, I, (C₁-C₄)-alkoxy, or H, and the definitions of the remaining symbols are those stated in formula (I), so that the reaction product has from 0.5 to 40% by weight phosphorus content.

The invention also provides the use of the phosphorylated polyether of the invention as flame retardant, and also provides a process for rendering a material flame-retardant, where a flame retardant comprising one or more polyethers of the invention is added to the material. The material is preferably a polymer material, in particular a polymer foam.

The polyethers and polycarbonates used in the invention are suitable for use as flame retardants for styrene polymers, in particular foams. Preference is given to the use of the polyethers (ii-1) of the invention. It is preferable that one polyether of the invention or one a polycarbonate of the invention is used as flame retardant.

Preference is further given to a mixture of at least two, particularly preferably from two to four, with particular preference two, polyethers and/or polycarbonates of the invention as flame retardants.

The amount generally used of the polyethers and/or polycarbonates used in the invention is in the range from 0.1 to 25 parts by weight, based on the material requiring protection, in particular polymer material. Amounts of from 2 to 15 parts by weight, based on the polymer, provide adequate flame retardancy in particular for foams made of expandable polystyrene.

The effectiveness of the polyethers and/or polycarbonates of the invention can be still further improved via addition of suitable flame retardant synergists, in particular of thermal free-radical generators, and preferably of organic peroxides, such as dicumyl peroxide or di-tert-butyl peroxide, of organic polysulfides, i.e. sulfides having a chain made of three or more sulfur atoms, or of C—C-cleaving initiators, such as biscumyl (2,3-diphenyl-2,3-dimethylbutane). In this case it is usual to use, in addition to the polyether(s) of the invention and/or to the polycarbonate(s) of the invention, from 0.05 to 5 parts by weight of the flame retardant synergist, based on the material requiring protection, in particular polymer material.

Elemental sulfur is equally preferred as synergist, preferably in a proportion of from 0.05 to 4 parts by weight, particularly preferably in a proportion of from 0.1 to 2.5 parts by weight (based on the material requiring protection, in particular polymer material).

The elemental sulfur can also be used in the form of starting compounds which are decomposed to elemental sulfur under the process conditions.

It is moreover possible to use elemental sulfur in encapsulated form. Examples of suitable encapsulation materials are melamine resins (by analogy with U.S. Pat. No. 4,440,880) and urea-formaldehyde resins (by analogy with U.S. Pat. No. 4,698,215). Further materials and citations from literature are found in WO 99/10429.

One preferred embodiment uses the polyether and/or the polycarbonate in combination with
at least one sulfur compound of the formula (II)

A¹-(Z¹)ₘ-(S)ₙ—(Z²)ₚ-A² (II)
where the definitions of the symbols and indices are as follows:
A¹ and A², being identical or different, are C₆-C₁₂-aryl, cyclohexyl, Si(OR^{a})₃, a saturated, to some extent unsaturated, or aromatic, mono- or bicyclic ring system which has from 3 to 12 ring members and which comprises one or more heteroatoms from the group N, O, and S, and which is unsubstituted or has substitution by one or more substituents from the group of 0, OH, S, SH, NH₂, COOR^{b}, CONR^{c}R^{d}, C₁-C₁₈-alkyl, C₁-C₁₈-alkoxy, C₁-C₁₈-thioalkyl, C₆-C₁₂-aryl, C₆-C₁₂-aryloxy, C₂-C₁₈-alkenyl, C₂-C₁₈-alkenoxy, C₂-C₁₈-alkynyl, and C₂-C₁₈-alkynoxy;
Z¹, and Z² being identical or different, are —CO— or —CS—;
R^{a} is C₁-C₁₈-alkyl;
R^{b}, R^{c}, and R^{d}, being identical or different, are H, C₁-C₁₈-alkyl, C₆-C₁₂-aryl or an aromatic, mono- or bicyclic ring system which has from 3 to 12 ring members and which comprises one or more heteroatoms from the group N, O, and S;
m and p, being identical or different, are 0 or 1, and
n is a natural number from 2 to 10.

Particular preference is given here to the following compounds of the formula (II)

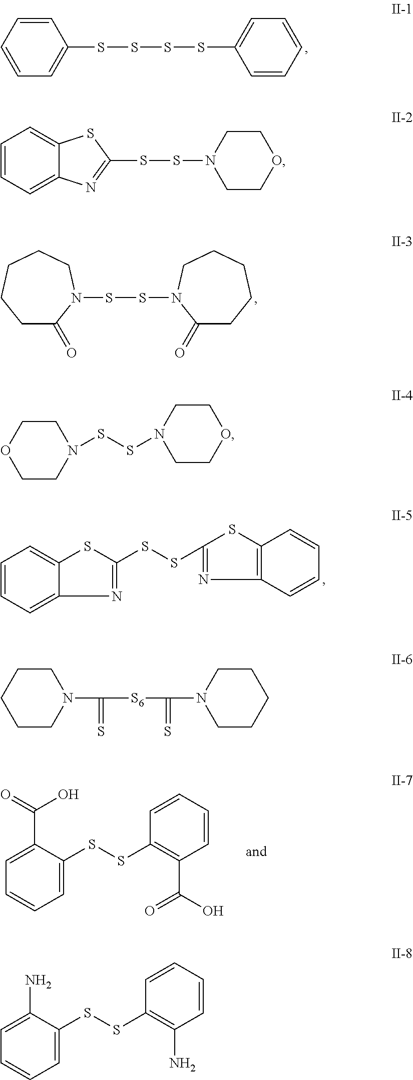

Most of the abovementioned compounds (II) are described in WO 2011/121 001.

Another preferred embodiment of the invention uses the polyether and/or the polycarbonate in combination with

a) at least one sulfur compound of the formula (III)

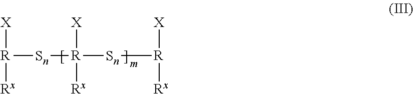

where the definitions of the symbols and indices are as follows:
R, being identical or different, preferably identical, is C₆-C₁₂-aryl, a 5-10-membered heteroaryl group which comprises one or more heteroatoms from the group of N, O, and S, C₁-C₁₆-alkyl, C₂-C₁₈-alkenyl, C₃-C₁₆-alkynyl, or C₃-C₁₀-cycloalkyl;
X, being identical or different, preferably identical, is OR^{y}, SR^{y}, NR^{y}R^{z}, COOR^{y}, CONR^{y}, SO₂R^{y}, F, Cl, Br, R, H, or a group —Y¹—P(Y²)ₚR′R″;
Y¹ is O, S, or NR″′;
Y² is O or S;
p is 0 or 1;
R′ and R″, being identical or different, preferably identical, are C₁-C₁₈-alkyl, C₂-C₁₈-alkenyl, C₂-C₁₈-alkynyl, C₆-C₁₂-aryl, C₃-C₁₀-cycloalkyl, C₆-C₁₂-aryl-C₁-C₁₈-alkyl, or a heteroaryl group or heteroaryloxy group which comprises one or more heteroatoms from the group N, O, and S, O—(C₁-C₁₈)-alkyl, O—(C₂-C₁₈)-alkenyl, O—(C₂-C₁₀)-alkynyl, O—(C₆-C₁₂)-aryl, O—(C₃-C₁₀)-cycloalkyl or O—(C₆-C₁₂)-aryl-(C₁-C₁₈)-alkyl;
R″′ is H, C₁-C₁₈-alkyl or (P(Y²)ₚR′R″);
R^{x}, being identical or different, preferably identical, is C₁-C₁₈-alkyl, C₂-C₁₀-alkenyl, C₂-C₁₀-alkynyl, C₆-C₁₂-aryl, C₃-C₁₀-cycloalkyl, C₆-C₁₂-aryl-C₁-C₁₈-alkyl, a heteroaryl group which comprises one or more heteroatoms from the group of N, O, and S, C₁-C₁₈-alkyl, C₂-C₁₆-alkenyl, C₂-C₁₃-alkynyl or C₃-C₁₀-cycloalkyl, O—(C₁-C₁₈)-alkyl, O—(C₂-C₁₈)-alkenyl, O—(C₂-C₁₀)-alkynyl, O—(C₆-C₁₂)-aryl, O—(C₃-C₁₀)-cycloalkyl, O—(C₆-C₁₂)-aryl-(C₁-C₁₈)-alkyl, S—(C₁-C₁₈)-alkyl, S—(C₁-C₁₈)-alkenyl, S—(C₂-C₁₀)-alkynyl, S—(C₆-C₁₂)-aryl, S—(C₂-C₁₀)-cycloalkyl, (C₆-C₁₂)-aryl-(C₁-C₁₈)-alkyl-S, OH, F, Cl, Br or H;
R^{y} and R^{z} being identical or different, preferably identical, are H, C₁-C₁₈-alkyl, C₂-C₁₈-alkenyl, C₂-C₁₈-alkynyl, C₆-C₁₂-aryl, C₃-C₁₀-cycloalkyl, C₆-C₁₂-aryl-C₁-C₁₈-alkyl, or a heteroaryl group which comprises one or more heteroatoms from the group of N, O, and S,
n is an integer from 1 to 8, and
m is a number from 1 to 1000.

Compounds (III) to which particular preference is given are the compounds poly(tert-butylphenol disulfide) and poly(tert-amylphenol disulfide) listed in the examples.

Preference is therefore also given to a use of the invention in which the polyethers and polycarbonates of the invention are used in a mixture with one or more further flame-retardant compounds and/or with one or more synergists.

It is also possible to make additional use of further flame retardants, such as melamine, melamine cyanurates, metal oxides, metal hydroxides, phosphates, phosphonates, DOPO (9,10-dihydro-9-oxa-10-phosphapheneanthrene 10-oxide) and DOPO derivatives, phosphinates, phosphites, phosphinites, expandable graphite, or synergists, such as Sb₂O₃, Sn compounds, or compounds which comprise or liberate nitroxyl radicals. Examples of suitable additional halogen-free flame retardants are available commercially as Exolit® OP 930, Exolit® OP 1312, HCA®, HCA-HQ®, Cyagard® RF-1243, Fyrol® PMP, Phoslite® IP-A, Melapur® 200, Melapur® MC, and Budit® 833.

If complete freedom from halogen is not essential, reduced-halogen-content materials can be produced via use of the flame retardant of the invention and addition of relatively small amounts of halogen-containing, in particular brominated, flame retardants, such as hexabromocyclododecane (HBCD), or of brominated styrene homo- or copolymers/oligomers (e.g. styrene-butadiene copolymers, as described in WO-A 2007/058736), preferably in amounts in the range from 0.05 to 1 part by weight, in particular from 0.1 to 0.5 part by weight (based on the polymer).

In one preferred embodiment, the flame retardant of the invention is halogen-free.

It is particularly preferable that the composition made of the material requiring protection, of flame retardant, and of further additives, is halogen-free.

The material requiring protection is preferably a polymer composition, i.e. a composition which comprises one or more polymers and is preferably composed of one or more polymers. Preference is given to thermoplastic polymers. It is particularly preferable that the polymer material is a foam.

The flame retardants of the invention, i.e. polyethers and polycarbonates of the invention, alone or in a mixture with one another, and/or with synergists, and/or with further flame-retardant substances, are used in the invention for producing flame-retardant polymers, in particular thermoplastic polymers. For this, the flame retardants are preferably physically mixed with the corresponding polymer in the melt, and then first compounded in the form of polymer mixture with phosphorus contents of from 0.05 part by weight to 5 parts by weight (based on the polymer) and then, in a second step, further processed together with the same or another polymer. Another preferred alternative in the case of styrene polymers is the addition of the polyethers and polycarbonates of the invention prior to, during, and/or after production via suspension polymerization.

The invention also provides a, preferably thermoplastic, polymer composition comprising one or more polyethers and/or polycarbonates of the invention as flame retardant.

Examples of polymer that can be used are foamed or unfoamed styrene polymers, inclusive of ABS, ASA, SAN, AMSAN, SB, and HIPS polymers, polyimides, polysulfones, polyolefins, such as polyethylene and polypropylene, polyacrylates, polyether polyol ether ketones, polyurethanes, polycarbonates, polyphenylene oxides, unsaturated polyester resins, phenolic resins, polyamides, polyether sulfones, polyether ketones, and polyether sulfides, in each case individually or in a mixture in the form of polymer blends.

Preference is given to thermoplastic polymers, such as foamed or unfoamed styrene homo- and copolymers, in each case individually or in a mixture in the form of polymer blends.

Preference is given to flame-retardant polymer foams, in particular those based on styrene polymers, preferably EPS and XPS.

In one preferred embodiment of the invention, the polymer foam of the invention based on one or more styrene polymers comprises one or more polyethers (ii-1) of the invention and no polycarbonate (ii-2) of the invention.

In another preferred embodiment of the invention, the polymer foam of the invention based on one or more styrene polymers comprises one or more polycarbonates (ii-2) of the invention and no polyether (ii-1) of the invention.

The polymer foam comprising one or more of components (ii-1) and/or (ii-2) and an expandable styrene polymer is in particular obtainable via an extrusion process or a suspension process. The invention therefore also provides a process for producing a flame-retardant, expandable styrene polymer (EPS), by way of example comprising the following steps:
a) mixing to incorporate an organic blowing agent and one or more polycarbonates and/or polyethers of the invention and optionally further auxiliaries and additives into a styrene polymer melt by means of static and/or dynamic mixers at a temperature of at least 150° C.,
b) cooling of the styrene polymer melt comprising blowing agent to a temperature of at least 120° C.,
c) discharge through a die plate with holes, the diameter of which at the die outlet is at most 1.5 mm, and
d) pelletization of the melt comprising blowing agent directly behind the die plate under water at a pressure in the range from 1 to 20 bar.

Preference is equally given to a process for producing an expandable styrene polymer of the invention, comprising the following steps:
a′) polymerization of one or more styrene monomers in suspension;
b′) addition of one or more polyethers (ii-1) and/or polycarbonates (ii-2) of the invention and also optionally of further auxiliaries and additives prior to, during and/or after the polymerization reaction;
c′) addition of an organic blowing agent prior to, during, and/or after the polymerization reaction, and
d′) isolation, from the suspension, of the expandable styrene polymer particles comprising one or more polyethers (ii-1) and/or polycarbonates (ii-2).

As the person skilled in the art is aware, addition after the polymerization reaction can take place only if the flame retardant has adequate solubility in the polymer and/or blowing agent.

The invention further provides a process for producing an extruded styrene foam (XPS) comprising the following steps:
a″) heating of a polymer component P which comprises at least one styrene polymer, to form a polymer melt,
b″) introduction of a blowing agent component T into the polymer melt to form a foamable melt,
c″) extrusion of the foamable melt into a region of relatively low pressure with foaming to give an extruded foam, and
d″) addition of at least one polyether (ii-1) and/or polycarbonate (ii-2) of the invention as flame retardant and also optionally of further auxiliaries and additives in at least one of steps a″) and b″).

The density of the flame-retardant polymer foams is preferably in the range from 5 to 200 kg/m³, particularly preferably in the range from 10 to 50 kg/m³, and their closed cell content is preferably more than 80%, particularly preferably from 90 to 100%.

The flame-retardant, expandable styrene polymers (EPS) and extruded styrene polymer foams (XPS) of the invention can be processed via addition of the blowing agent and of the flame retardant of the invention prior to, during, or after the suspension polymerization reaction, or via mixing to incorporate a blowing agent and the flame retardant of the invention into the polymer melt, and then extrusion and pelletization under pressure to give expandable pellets (EPS), or via extrusion and depressurization, using appropriately shaped dies, to give foam sheets (XPS) or foam extrudates.

The term styrene polymer in the invention comprises polymers based on styrene, alpha-methylstyrene, or a mixture of styrene and alpha-methylstyrene; this applies analogously to the styrene content in SAN, AMSAN, ABS, ASA, MBS, and MABS (see below). Styrene polymers of the invention are based on at least 50% by weight of styrene and/or alpha-methylstyrene monomers.

In one preferred embodiment, the polymer is an expandable polystyrene (EPS).

In another preferred embodiment, the foam is an extruded styrene polymer foam (XPS).

The molar mass M_{w} of expandable styrene polymers is preferably in the range from 120 000 to 400 000 g/mol, particularly preferably in the range from 180 000 to 300 000 g/mol, measured by means of gel permeation chromatography with refractiometric detection (RI) against polystyrene standards. The molar mass of the expandable polystyrene is generally below the molar mass of the polystyrene used by about 10 000-40 000 g/mol because of the molar mass degradation due to shear and/or the effect of temperature.

Styrene polymers preferably used comprise glassclear polystyrene (GPPS), high-impact polystyrene (HIPS), anionically polymerized polystyrene or high-impact polystyrene (AIPS), styrene-alpha-methylstyrene copolymers, acrylonitrile-butadiene-styrene polymers (ABS), styrene-butadiene copolymers (SB), styrene-acrylonitrile copolymers (SAN), acrylonitrile-alpha-methylstyrene copolymers (AMSAN), styrene-maleic anhydride copolymers (SMA), styrene-methyl methacrylate copolymers (SMMA), styrene-N-phenylmaleimide copolymers (SPMI), acrylonitrile-styrene-acrylate (ASA), methyl methacrylate-butadiene-styrene (MBS), methyl methacrylate-acrylonitrile-butadiene-styrene (MABS) polymers, or a mixture thereof, or a mixture with polyphenylene ether (PPE).

In order to improve mechanical properties or thermal stability, the styrene polymers mentioned may be blended with thermoplastic polymers, such as polyamides (PAs), polyolefins, such as polypropylene (PP) or polyethylene (PE), polyacrylates, such as polymethyl methacrylate (PMMA), polycarbonate (PC), polyesters, such as polyethylene terephthalate (PET) or polybutylene terephthalate (PBT), polyether polyol sulfones (PES), polyether ketones or polyether sulfides (PES) or mixtures of these, generally in total proportions of up to a maximum of 30% by weight, preferably in the range from 1 to 10% by weight, based on the polymer melt, where appropriate with use of compatibilizers. Mixtures within the ranges of amounts mentioned are also possible with, by way of example, hydrophobically modified or functionalized polymers or oligomers, rubbers, such as polyacrylates or polydienes, e.g. styrene-butadiene block copolymers, or biodegradable aliphatic or aliphatic/aromatic copolyesters.

Examples of suitable compatibilizers are maleic-anhydride-modified styrene copolymers, polymers containing epoxy groups, and organosilanes.

The styrene polymer melt can also receive admixtures of polymer recyclates derived from the thermoplastic polymers mentioned, in particular additions of styrene polymers and of expandable styrene polymers (EPS), in amounts which do not substantially impair their properties, the amounts generally being at most 50% by weight, in particular from 1 to 20% by weight.

The styrene polymer melt comprising blowing agent generally comprises one or more blowing agents homogeneously distributed in a total proportion of from 2 to 10% by weight, preferably from 3 to 7% by weight, based on the styrene polymer melt comprising blowing agent. Suitable blowing agents are the physical blowing agents usually used in EPS, such as aliphatic hydrocarbons having from 2 to 7 carbon atoms, alcohols, ketones, ethers, or halogenated hydrocarbons. Preference is given to use of isobutane, n-butane, isopentane and/or n-pentane. For XPS, it is preferable to use CO₂ or a mixture thereof with alcohols and/or with C₂-C₄ carbonyl compounds, in particular with ketones.

To improve foamability, finely dispersed droplets of internal water may be introduced into the styrene polymer matrix. An example of the method for this is the addition of water into the molten styrene polymer matrix. The location of addition of the water may be upstream of, together with, or downstream of, the blowing agent feed. Homogeneous distribution of the water may be achieved by using dynamic or static mixers. An adequate amount of water, based on the styrene polymer, is generally from 0 to 2% by weight, preferably from 0.05 to 1.5% by weight.

Expandable styrene polymers (EPSs) with at least 90% of the internal water in the form of droplets of internal water with diameter in the range from 0.5 to 15 μm form, on foaming, foams with an adequate number of cells and with homogeneous foam structure.

The amount added of blowing agent and of water is selected in such a way that the expansion capability α of the expandable styrene polymers (EPSs), defined as bulk density prior to foaming/bulk density after foaming, is at most 125, preferably from 15 to 100.

The bulk density of the expandable styrene polymer pellets (EPSs) of the invention is generally at most 700 g/l, preferably in the range from 590 to 660 g/l. If fillers are used, bulk densities in the range from 590 to 1200 g/l may arise, depending on the nature and amount of the filler.

Additives, nucleating agents, fillers, plasticizers, soluble and insoluble inorganic and/or organic dyes and pigments, e.g. IR absorbers, such as carbon black, graphite or aluminum powder may moreover be added, together or with spatial separation, to the styrene polymer melt, e.g. by way of mixers or ancillary extruders. The amounts added of the dyes and pigments are generally in the range from 0.01 to 30% by weight, preferably in the range from 1 to 5% by weight. For homogeneous and microdisperse distribution of the pigments within the styrene polymer, it can be advantageous, particularly in the case of polar pigments, to use a dispersing agent, e.g. organosilanes, polymers containing epoxy groups, or maleic-anhydride-grafted styrene polymers. Preferred plasticizers are mineral oils, phthalates, which may be used in amounts of from 0.05 to 10% by weight, based on the styrene polymer. By analogy, these substances can also be added to the EPS of the invention prior to, during, or after the suspension polymerization reaction.

To produce the expandable styrene polymers of the invention, the blowing agent can be incorporated by mixing into the polymer melt after the pelletization process. One possible process comprises the following stages: i) melt production, ii) mixing, iii) cooling, iv) transport, and v) pelletizing. Each of these stages may be executed using the apparatus or combinations of apparatus known from plastics processing. Static or dynamic mixers, such as extruders, are suitable for this mixing process. The polymer melt may be taken directly from a polymerization reactor, or produced directly in the mixing extruder, or in a separate melting extruder via melting of polymer pellets. The cooling of the melt may take place in the mixing assemblies or in separate coolers. Examples of pelletizers which may be used are pressurized underwater pelletizers, a pelletizer with rotating knives and cooling via spray-misting of temperature-control liquids, or pelletizers involving atomization. Examples of suitable arrangements of apparatus for carrying out the process are:

a) polymerization reactor—static mixer/cooler—pelletizer
b) polymerization reactor—extruder—pelletizer
c) extruder—static mixer—pelletizer
d) extruder—pelletizer

The arrangement may also have ancillary extruders for introducing additives, e.g. solids or heat-sensitive additives.

The temperature of the styrene polymer melt comprising blowing agent when it is passed through the die plate is generally in the range from 140 to 300° C., preferably in the range from 160 to 240° C. Cooling to the region of the glass transition temperature is not necessary.

The die plate is heated at least to the temperature of the polystyrene melt comprising blowing agent. The temperature of the die plate is preferably above the temperature of the polystyrene melt comprising blowing agent by from 20 to 100° C. This avoids polymer deposits in the dies and ensures problem-free pelletization.

In order to obtain marketable pellet sizes, the diameter (D) of the die holes at the exit from the die should be in the range from 0.2 to 1.5 mm, preferably in the range from 0.3 to 1.2 mm, particularly preferably in the range from 0.3 to 0.8 mm. This permits controlled setting of pellet sizes below 2 m, in particular in the range from 0.4 to 1.4 mm, even after die swell.

It is also preferable to produce the expandable styrene polymers (EPS) of the invention via suspension polymerization in aqueous suspension in the presence of the flame retardant of the invention and of an organic blowing agent.

The suspension polymerization reaction preferably uses styrene as sole monomer. However, it is also possible to replace up to 20% by weight of the styrene by other ethylenically unsaturated monomers, such as alkylstyrenes, divinylbenzene, acrylonitrile, 1,1-diphenyl ether, or alpha-methylstyrene.

The usual auxiliaries can be added during the suspension polymerization process, examples being peroxide initiators, suspension stabilizers, blowing agents, chain-transfer agents, expansion aids, nucleating agents, and plasticizers. The amounts of flame retardant of the invention added in the polymerization process are from 0.5 to 25 parts by weight, preferably from 5 to 15 parts by weight based on the monomer. The amounts of blowing agents added are from 2 to 10 parts by weight, based on monomer. These amounts can be added prior to, during, or after polymerization of the suspension. Examples of suitable blowing agents are aliphatic hydrocarbons having from 4 to 6 carbon atoms. It is advantageous to use inorganic Pickering dispersants as suspension stabilizers, an example being magnesium pyrophosphate or calcium phosphate.

The suspension polymerization process produces bead-shaped particles which are in essence round, with average diameter in the range from 0.2 to 2 mm.

In order to improve processability, the finished expandable styrene polymer pellets can be coated with glycerol ester, antistatic agent, or anticaking agent.

The EPS pellets can be coated with glycerol monostearate GMS (typically 0.25 part by weight), glycerol tristearate (typically 0.25 part by weight), Aerosil R972 fine-particle silica (typically 0.12 part by weight), or Zn stearate (typically 0.15 part by weight), or else antistatic agent.

The expandable styrene polymer pellets of the invention can be prefoamed in a first step by means of hot air or steam to give foam beads with density in the range from 5 to 200 kg/m³, in particular from 10 to 50 kg/m³, and can be fused in a second step in a closed mold, to give molded foams.

The expandable polystyrene particles can be processed to give polystyrene foams with densities of from 8 to 200 kg/m³, preferably from 10 to 50 kg/m³. To this end, the expandable beads are prefoamed. This is mostly achieved by heating of the beads, using steam in what are known as prefoamers. The resultant prefoamed beads are then fused to give moldings. To this end, the prefoamed beads are introduced into molds which do not have a gas-tight seal, and are treated with steam. The moldings can be removed after cooling.

In another preferred embodiment, the foam is an extruded polystyrene (XPS), obtainable via the process described above:

Foams of the invention based on styrene polymers, in particular EPS and XPS, are suitable by way of example for use as insulation materials, in particular in the construction industry. A preferred use is as halogen-free insulation material, in particular in the construction industry.

The extinguishment time (DIN 4102 B2 fire test for aging time 72 h and for foam density of 15 g/l unless otherwise stated) of foams of the invention, in particular those based on styrene polymers, for example EPS and XPS, is preferably ≦15 sec, particularly preferably ≦10 sec, and they thus satisfy the conditions for passing said fire test, as long as the flame height does not exceed the test level stated in the standard.

The examples below provide further explanation of the invention, but without any resultant restriction.

### EXAMPLES

### I Synthesis Examples

### Phosphorylated Polyethers and Polycarbonates Used

| | | |
|---|---|---|
| 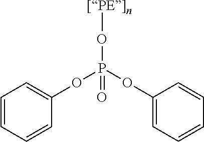 | Hyperbranched polyether reacted with diphenyl chlorophosphate; OH number: 5 mg KOH/g; 9.4% by weight of P | PV1 |
| 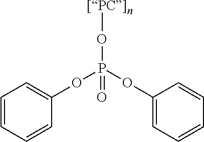 | Hyperbranched polycarbonate reacted with diphenyl chlorophosphate; OH number: 21 mg KOH/g; 7.8 by weight of P | PV2 |
| 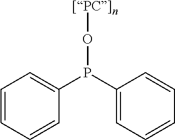 | Hyperbranched polycarbonate reacted with chlorodiphenylphosphine; OH number: 53 mg KOH/g; 7.8 by weight of P | PV3 |
| 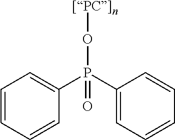 | Hyperbranched polycarbonate reacted with diphenylphosphinyl chloride; OH number: 2 mg KOH/g; 9.1 by weight of P | PV4 |

### Synergists Used:

| | | |
|---|---|---|
| S₈ | Sulfur | SV1 |
| 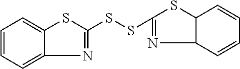 | 2,2- Dithiobis (benzothiazole) | SV2 |
| 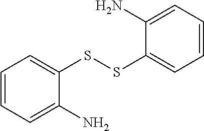 | 2- Aminophenyl disulfide | SV3 |
| 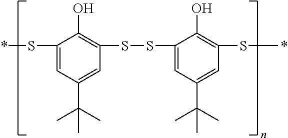 | Poly(tert- amylphenol disulfide) | SV4 |
| 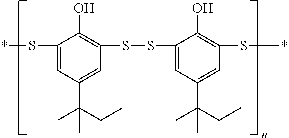 | Poly(tert- amylphenol disulfide) | SV5 |
| 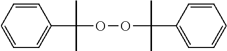 | Dicumyl peroxide (DCP) | SV6 |

The organophosphorus compounds and synergists used in the examples were synthesized or purchased:

SV1: purchased from Sigma Aldrich.
SV2: Vulkacit DM/C from Lanxess.
SV3: purchased from Sigma Aldrich.
SV4: purchased from Arkema
SV5: purchased from Arkema

The phosphorylation reactions described below for the respective hyperbranched polymers exhibit typical phosphorylation sequences.

They can generally be applied to a large number of different hyperbranched polyols, and also to a large number of appropriate chlorophosphines and chlorophosphates, irrespective of the phosphorus content finally obtained.

### A1 Synthesis of Phosphorylated Hyperbranched Polyethers

a) Synthesis of a Hyperbranched Polyether from Pentaerythritol and Triethylene Glycol

The polymerization reaction was carried out in a 4 l glass flask, equipped with a stirrer, reflux condenser, and a distillation bridge with vacuum connection. The mixture of pentaerythritol (1225.4 g), triethylene glycol (1351.2 g), and trifluoromethanesulfonic acid (catalyst, 2.0 g) was evacuated and slowly heated to 180° C. by means of an oil bath at a pressure of from 200 to 300 mbar. Once reaction temperature had been reached, the reaction mixture was stirred, and water was removed by way of the distillation bridge. The water removed by distillation was collected in a cooled round-bottomed flask and weighed in order to determine percentage conversion for comparison with the full conversion theoretically possible.

The reaction mixture was then allowed to cool in vacuo. KOH (50% aqueous) was added to neutralize the reaction solution. The product was then stripped in vacuo (70 mbar) and cooled.

The product of the invention was analyzed by means of gel permeation chromatography, using a refractometer as detector. Hexafluoroisopropanol (HFIP) was used as mobile phase, and polymethyl methacrylate (PMMA) was used as standard for molecular weight determination. OH number was determined to DIN 53240.
Molar masses (GPC):
Mn: 1446 g/mol
Mw: 10432 g/mol
OHN: 592 mg KOH/g
b) Phosphation of the hyperbranched polyether described in A1 a), using diphenyl chlorophosphate (PV1)

50 g of polyether were introduced into dry methylene chloride (500 mL) in an argon-inertized standard 1 L four-necked stirred apparatus. Triethylamine (70 g, 0.69 mol) was added in one portion to this mixture. Within 90 min., diphenyl chlorophosphate (145 g, 0.54 mol) was added dropwise at from 24 to 27° C. Once the dropwise addition had ended, stirring of the reaction mixture was continued at room temperature for 4 h.

The reaction mixture was cooled to room temperature and washed with aqueous sodium hydroxide solution (500 mL, 5% (w/w)), and finally with water (500 L). The resultant organic phase was dried over Na₂SO₄, and then the volatile constituents were removed in vacuo (10 mbar) on a rotary evaporator.

The product was isolated in the form of yellowish resin (141.5 g). ³¹P NMR (CDCl₃), [ppm]: (−)10.2-(−)13.1 (m). OH number: 5 mg KOH/g. P content: 9.4%.

### B1 Synthesis of Phosphorylated Hyperbranched Polycarbonates

### a) Synthesis of a Hyperbranched Polycarbonate:

2400 g of a triol composed of trimethylolpropane randomly grafted with 1.2 mol of propylene oxide, diethyl carbonate (1417.5 g), and K₂CO₃ (0.6 g) as catalyst (250 ppm of catalyst, based on mass of triol) were used as initial charge in a 4 L three-necked flask, equipped with stirrer, reflux condenser, and internal thermometer. The mixture was heated to 120° C.-140° C. and stirred at this temperature for 2 h. To about 110° C. as reaction time increased, the temperature of the reaction mixture decreased as a result of onset of evaporative cooling by the ethanol liberated. At this temperature, the reflux condenser was replaced by an inclined condenser, ethanol and other low-boiling-point constituents were removed by distillation, and the temperature of the reaction mixture was increased slowly up to 160° C. The weighed amount of distillate was 795 g.

### Analysis:

The reaction product was then analyzed by gel permeation chromatography, using dimethylacetamide as eluent and polymethyl methacrylate (PMMA) as standard. The values determined were as follows:
Mₙ: 827 g/mol
M_{w}: 1253 g/mol
OH number was determined to DIN 53240:
OH number: 416 mg KOH/g

### b) Phosphation of the Hyperbranched Polycarbonate Described Under B1 a), Using Diphenyl Chlorophosphate (PV2).

A hyperbranched polycarbonate (1211 g, 0.96 mol, OH number: 387 mg KOH/g) was dissolved in dry toluene (2200 mL) in an argon-inertized 10 L glass reactor. Triethylamine (930 g, 9.2 mol) was added in one portion to this solution. The mixture was heated to a temperature of 80° C. At this temperature, diphenyl chlorophosphate (2418 g, 9.0 mol) was added dropwise within a period of 120 min. An exothermic reaction began, and reaction temperature was maintained at 80-90° C. via external cooling. Once the dropwise addition had ended, stirring of the reaction mixture was continued at 80° C. for 6 h. Reaction monitoring via ³¹P NMR indicated complete conversion, based on diphenyl chlorophosphate used.

The reaction mixture was cooled to room temperature and washed first with water (2 L) and then with aqueous sodium hydroxide solution (2×1 L, 5% (w/w)), and then again with water (2×2 L). The resultant organic phase was dried over Na₂SO₄, and then the volatile constituents were removed in vacuo (10 mbar) on a rotary evaporator. The product was isolated in the form of yellowish oil (2377 g). ³¹P NMR (toluene_{d8}), [ppm]: −11-12 (m). OH number: 21 mg KOH/g. P content: 7.8%.

### c) Phosphorylation of a Hyperbranched Polycarbonate Using Diphenylchlorophosphine (PV3).

A hyperbranched polycarbonate (411 g, 0.30 mol, OH number: 387 mg KOH/g) was dissolved in dry toluene (2200 mL) in an argon-inertized 6 L glass reactor. Triethylamine (273 g, 2.70 mol) was added in one portion to this solution. The mixture was heated to a temperature of 80° C. At this temperature, diphenylchlorophosphine (567.6 g, 2.57 mol) was added dropwise within a period of 60 min. An exothermic reaction began, and reaction temperature was maintained at 80-90° C. via external cooling. Once the dropwise addition had ended, stirring of the reaction mixture was continued at 80° C. for 6 h. Reaction monitoring via ³¹P NMR indicated complete conversion, based on diphenylchlorophosphine used.

The reaction mixture was cooled to room temperature and washed first with water (1.5 L) and then with aqueous sodium hydroxide solution (1 L, 5% (w/w)), and then again with water (1 L). The resultant organic phase was dried over Na₂SO₄, and then the volatile constituents were removed in vacuo (10 mbar) on a rotary evaporator. The product was isolated in the form of yellowish oil (849 g). ³¹P NMR (toluene_{d8}), [ppm]: 108-117 (m). OH number: 53 mg KOH/g. P content: 7.8%.

### d) Phosphorylation of the Hyperbranched Polycarbonate Described Under B1 a), Using Diphenylphosphinyl Chloride (PV4).

A hyperbranched polycarbonate (403.5 g, 0.32 mol, OH number: 416 mg KOH/g) was dissolved in dry toluene (400 mL) in an argon-inertized standard 2 L four-necked stirred apparatus. Triethylamine (379.5 g, 3.75 mol) was added in one portion to this solution. The mixture was heated to a temperature of 80° C. At this temperature, diphenylphosphinyl chloride (710.5 g, 3.0 mol) was added dropwise within a period of 120 min. An exothermic reaction began, and reaction temperature was maintained at 80-90° C. via external cooling. Once the dropwise addition had ended, stirring of the reaction mixture was continued at 80° C. for 12 h. Reaction monitoring via ³¹P NMR indicated complete conversion, based on diphenylphosphinyl chloride used.

The reaction mixture was cooled to room temperature and washed first with aqueous sodium bicarbonate solution (2×1 L, 10% (w/w)) and then with water (500 mL). The resultant organic phase was dried over Na₂SO₄, and then the volatile constituents were removed in vacuo (10 mbar) on a rotary evaporator. The product was isolated in the form of yellowish oil (805 g, 81% of theory). ³¹P NMR (toluene_{d8}), [ppm]: 31.1-28.9 (m). OH number: 2 mg KOH/g. P content: 9.1%.

### Application Examples

### Flame Retardancy Tests

### Description of Tests:

Unless otherwise stated, the foam density used for determination to DIN 4102 (fire test B2) of the fire performance of the foam sheets was 15 kg/m³.

Hexabromocyclododecane (termed HBCD below) was used as comparison.

### Expandable Styrene Polymers (Extrusion Process)

7 parts by weight of n-pentane were incorporated by mixing into a polystyrene melt made of PS 148H (Mw=240 000 g/mol, Mn=87 000 g/mol, determined by means of GPC, RI detector, polystyrene (PS) as standard) from BASF SE with intrinsic viscosity IV of 83 ml/g. After cooling of the melt comprising blowing agent from initially 260° C. to a temperature of 190° C., a polystyrene melt which comprised the flame retardants mentioned in the table was incorporated by mixing into the main stream by way of an ancillary extruder.

The amounts stated in parts by weight are based on the entire amount of polystyrene.

The mixture of polystyrene melt, blowing agent, and flame retardant was conveyed at 60 kg/h through a die plate with 32 holes (diameter of dies 0.75 mm). Compact pellets with narrow size distribution were produced by pressurized underwater pelletization.

The molar mass of the pellets was 220 000 g/mol (Mw) and, respectively, 80 000 g/mol (Mn) (determined by means of GPC, RI detector, PS as standard). The pellets were prefoamed via exposure to a current of steam and after 12 hours inventory were fused via further treatment with steam in a closed mold to give foam slabs of density 15 kg/m³. The fire performance of the foam sheets was determined for foam density of 15 kg/m³ to DIN 4102 after 72 hours inventory.

Tables 1-5 collect the results

TABLE 1
Fire performance of polymer composition of the invention (inventive
examples) and of comparative examples

| | Flame retardant | Synergist | Fire test (B2 to DIN |
|---|---|---|---|
| | (parts by weight, | (parts by weight, | 4102)/ |
| | based on | based on | extinguishment |
| Example | polystyrene) | polystyrene) | time (s) |
| CE1 | — | — | not passed/burns |
| CE2 | HBCD (4.0) | — | passed/6.4 s |
| 1 | PV4 (20.0) | — | passed/11.5 s |
| 2 | PV2 (20.0) | — | passed/9.7 s |
| 3 | PV3 (20.0) | — | passed/13.4 s |
| 4 | PV1 (20.0) | — | passed/8.4 s |
| 5 | PV4 (2.5) | SV2 (5.0) | passed/8.1 s |
| 6 | PV4 (2.5) | SV3 (2.0) | passed/6.7 s |
| 7 | PV4 (2.5) | SV4 (2.5) | passed/8.6 s |
| 8 | PV4 (2.5) | SV5 (2.5) | passed/7.2 s |
| 9 | PV2 (2.5) | SV2 (5.0) | passed/9.9 s |
| 10 | PV2 (2.5) | SV4 (2.5) | passed/8.5 s |
| 11 | PV3 (2.5) | SV1 (2.0) | passed/12.6 s |
| 12 | PV3 (2.5) | SV3 (2.0) | passed/10.1 s |
| 13 | PV1 (2.5) | SV2 (5.0) | passed/8.8 s |
| 14 | PV1 (2.5) | SV5 (2.5) | passed/6.5 s |

TABLE 2
Effect of foam density of polystyrene foam test specimens produced
from EPS on fire result.

| | Flame retardant | | Fire test (B2 to |
|---|---|---|---|
| | (parts by weight, | Foam density | DIN 4102)/ |
| | based on | [kg/m³] | extinguishment |
| Example | polystyrene) | (ISO 845) | time (s) |
| 9 | PV2 (2.5) + S2 (5.0) | 14.9 | passed/8.1 s |
| 15 | PV2 (2.5) + S2 (5.0) | 53.7 | passed/11.8 s |
| 16 | PV2 (2.5) + S2 (5.0) | 108.2 | passed/15.4 s |
| 17 | PV2 (2.5) + S2 (5.0) | 179.5 | not passed/burns |

TABLE 3
Effect of the flame retardants on the heat resistance of
polystyrene foam test specimens produced from EPS.

| | | Heat resistance |
|---|---|---|
| | | (to DIN EN 1604; |
| | Flame retardant | linear dimensional |
| | (parts by weight, based | change after 48 h, |
| Example | on polystyrene) | 70° C.) (%) |
| CE1 | — | 0.0 |
| CE2 | HBCD (4.0) | 0.5 |
| 1 | PV4 (20.0) | >5 |
| 4 | PV1 (20.0) | >5 |
| 5 | PV4 (2.5) + SV2 (5.0) | 1.9 |
| 10 | PV2 (2.5) + SV4 (2.5) | 0.8 |
| 14 | PV1 (2.5) + SV5 (2.5) | 1.0 |

TABLE 4
Effect of the flame retardants on compressive stress for
polystyrene foam test specimens produced from EPS.

| | Flame retardant | |
|---|---|---|
| | (parts by weight, | Compressive stress |
| Ex. | based on polystyrene) | (kPa) |
| CE2 | HBCD (4.0) | 75.2 |
| 1 | PV4 (20.0) | 63.7 |
| 4 | PV1 (20.0) | 63.4 |
| 5 | PV4 (2.5) + SV2 (5.0) | 69.5 |
| 10 | PV2 (2.5) + SV4 (2.5) | 74.8 |
| 14 | PV1 (2.5) + SV5 (2.5) | 75.3 |

### Styrene Polymers (Mini Extruder Experiments)

Polystyrene 148 H was extruded in a DSM Micro 15 extruder for a period of 5 min. at 180° C. with the respective flame retardant additives. The Vicat test specimens were injection molded in a DSM 10 cc micro-injection molding machine.

Table 5 collates the results of the Vicat tests.

TABLE 5
Effect of the flame retardants on Vicat softening point of
polystyrene test specimens

| | Flame retardant | Vicat softening |
|---|---|---|
| | (parts by weight, | point VST/B/50 |
| Example | based on polystyrene) | (° C.) (to ISO 306) |
| CE1 | — | 101 |
| CE2 | HBCD (4.0) | 96 |
| 18 | PV4 (20.0) | 75 |
| 19 | PV1 (20.0) | 74 |
| 20 | PV4 (2.5) + SV2 (5.0) | 89 |
| 21 | PV2 (2.5) + SV4 (2.5) | 91 |
| 22 | PV1 (2.5) + SV5 (2.5) | 92 |

### Expandable Styrene Polymers (Suspension Process)

To produce EPS, dibenzoyl peroxide, dicumyl peroxide, and optionally further synergists, and Ceridust 3620 (polyethylene wax, Clariant) were dissolved in styrene. The phosphorus-containing flame retardant of the invention was added to this material. The organic phase was introduced into deionized water in a stirred tank. The aqueous phase also comprised sodium pyrophosphate and magnesium sulfate heptahydrate (Epsom salt). The suspension was heated to 104° C. within a period of 1.75 hours, and then to 136° C. within a period of 5.5 hours. 1.8 hours after the temperature had reached 80° C., K30 emulsifier (a mixture of various linear alkylsulfonates, Lanxess AG) was metered into the mixture. After one further hour, 7.8% by weight of pentane were then added. Polymerization was then finally completed at a final temperature of 136° C.

The resultant polystyrene beads comprising blowing agent were isolated by decanting, dried to remove internal water, and coated with a standard EPS coating.

The polystyrene beads comprising blowing agent were prefoamed via exposure to a current of steam and after 12 hours inventory were fused via further treatment with steam in a closed mold to give foam slabs of density 15 kg/m³. The fire performance of the foam sheets was determined for foam density of 15 kg/m³ to DIN 4102 after 72 hours inventory.

Table 6 collates the results of the suspension polymerization reaction.

TABLE 6
Fire performance of polymer composition of the invention (inventive
examples) and of comparative examples

| | Flame retardant | | Fire test (B2 to DIN |
|---|---|---|---|
| | (parts by weight, | Synergist | 4102)/ |
| | based on | (parts by weight, | extinguishment |
| Example | styrene) | based on styrene) | time (s) |
| CE8 | — | — | not passed |
| CE9 | HBCD (3.5) | — | passed/7.1 s |
| 23 | PV4 (2.5) | S6 (1.5) | passed/10.4 s |
| 24 | PV2 (2.5) | S6 (1.5) | passed/12.7 s |
| 25 | PV3 (2.5) | S6 (1.5) | passed/11.1 s |
| 26 | PV1 (2.5) | S6 (1.5) | passed/9.7 s |

### Extruded Polystyrene Foam Sheets

100 parts by weight of polystyrene 158K (Mw=261 000 g/mol, Mn=77 000 g/mol, determined by means of GPC, RI detector, PS as standard) from BASF SE with intrinsic viscosity of 98 ml/g, 0.1 part of talc powder as nucleating agent to regulate cell size, and the parts stated in the table of flame retardants, and also optionally of sulfur or of other synergists, were continuously introduced into an extruder with an internal screw diameter of 120 mm. At the same time, a blowing agent mixture made of 3.25 parts by weight of ethanol and 3.5 parts by weight of CO₂ was continuously injected through an inlet aperture in the extruder. The gel uniformly kneaded at 180° C. in the extruder was passed through a relaxation zone and, after a residence time of 15 minutes, extruded with an outlet temperature of 105° C. through a die of breadth 300 mm and width 1.5 mm into the atmosphere. The foam was passed through a calibrator connected to the extruder, producing a foamed web sheet with 650 mm×50 mm cross section and density of 35 g/l. The molar mass of the polystyrene was 240 000 g/mol (Mw) or 70 000 g/mol (Mn) (determined by means of GPS, RI detector, PS as standard). The product was cut into sheets. The fire performance of the specimens was tested to DIN 4102 using thicknesses of 10 mm after a period of 30 days in inventory.

Table 7 collates the results from the examples.

TABLE 7
Fire performance of polymer composition of the invention
(inventive example) and of comparative examples

| | | Synergist | Fire test |
|---|---|---|---|
| | Flame retardant | (parts by weight, | (B2 to DIN 4102)/ |
| | (% by weight, based | based | extinguishment |
| Example | on styrene) | on styrene) | time (s) |
| CE10 | — | — | not passed/burns |
| CE11 | HBCD (4.0) | — | passed/7.2 s |
| 27 | PV4 (20.0) | — | passed/12.2 s |
| 28 | PV2 (20.0) | — | passed/13.7 s |
| 29 | PV4 (2.5) | S2 (5.0) | passed/7.9 s |
| 30 | PV4 (2.5) | S4 (2.5) | passed/9.5 s |
| 31 | PV2 (2.5) | S2 (5.0) | passed/10.3 s |
| 32 | PV2 (2.5) | S4 (2.5) | passed/8.5 s |
| 33 | PV3 (2.5) | S1 (2.5) | passed/7.2 s |
| 34 | PV3 (2.5) | S5 (2.5) | passed/8.8 s |
| 35 | PV1 (2.5) | S2 (5.0) | passed/8.7 s |
| 36 | PV1 (2.5) | S3 (2.5) | passed/5.1 s |

The application examples provide evidence that with the flame retardants of the invention it is possible to produce a foam which, without the use of halogenated flame retardants, exhibits fire performance identical with or better than that obtained with said agents.

1-27. (canceled)

28. A polymer composition comprising
i) one or more styrene polymers and
ii) one or more phosphorylated polyethers (ii-1) with from 0.5 to 40% by weight phosphorus content, the main chain of which is formed exclusively from carbon atoms and from oxygen atoms, and which has at least three terminal and/or pendant OH groups, where these have been substituted to some extent or
entirely with at least one phosphorus-containing group (I), 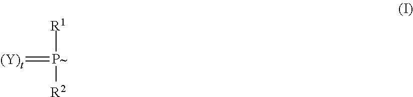
where the definitions of the symbols and indices are as follows:
˜ indicates the bond to the polymer skeleton of the polyether;
Y is 0 or S;
t is 0 or 1;
R¹ and R², being identical or different, are H, C₁-C₁₈-alkyl, C₂-C₁₈-alkenyl, C₂-C₁₈-alkynyl, C₃-C₁₀-cycloalkyl, C₆-C₁₀-aryl, furyl, C₆-C₁₀-aryl-C₁-C₁₀-alkyl, OR³, SR³, NR³R⁴, COR³, COORS or CONR³R⁴, or R¹ and R² form, together with the phosphorus atom P, a 4-8-membered ring system;
R³ and R⁴, being identical or different, are H, C₂-C₁₆-alkenyl, C₃-C₁₆-alkynyl, C₃-C₁₀-cycloalkyl, C₆-C₁₀-aryl, furyl, C₆-C₁₀-aryl-C₁-C₁₀-alkyl
where aryl groups in the moieties R¹, R², R³, and R⁴ are unsubstituted or have substitution by from 1 to 3 C₁-C₄-alkyl and/or C₁-C₄-alkoxy groups,
and/or
polycarbonates (ii-2) comprising one or more phosphorus-containing groups, where the phosphorus-containing group is a group of the general formula (I).

29. The polymer composition according to claim 28, wherein
Y is 0 or S;
t is 0 or 1;
R¹ and R², being identical or different, are C₁-C₁₈-alkyl, C₂-C₁₈-alkenyl, C₃-C₁₀-cycloalkyl, C₆-C₁₀-aryl, furyl or OR³,
R³ and R⁴, being identical or different, are C₁-C₁₈-alkyl, C₃-C₁₀-cycloalkyl or C₆-C₁₀-aryl, where aryl groups in the moieties R¹, R², R³ and R⁴ are unsubstituted or have substitution by from 1 to 3 C₁-C₄-alkyl or C₁-C₄-alkoxy groups.

30. The polymer composition according to claim 28, wherein
Y is 0;
t is 0 or 1;
R¹ and R² are identical and are C₁-C6-alkyl, cyclohexyl, phenyl, furyl, or OR³;
R³ is C₁-C₆-alkyl, cyclohexyl, or phenyl,
wherein phenyl moieties R¹, R², and R³ are unsubstituted or have substitution by C₁-C₄-alkyl and/or C₁-C₄-alkoxy.

31. The polymer composition according to claim 28, wherein
Y is 0;
t is 1;
R¹ and R² are identical and are phenyl, phenoxy, methoxyphenyl, tolyl, furyl, cyclohexyl, methoxy, or ethoxy.

32. The polymer composition according to claim 28, wherein the group of the formula (I) is (Ph)₂(0)P˜ or (PhO)₂(0)P˜ and wherein Ph is phenyl.

33. The polymer composition according to claim 28, comprising the polyether (ii-1), wherein the polyether is hyperbranched.

34. The polymer composition according to claim 28, comprising the polyether (ii-1) obtainable via reaction of at least one at least trihydric alcohol and optionally further di- and/or monohydric alcohols and/or modifier reagents.

35. The polymer composition according to claim 28, comprising the polyether (ii-1) obtainable from triethylene glycol and pentaerythritol.

36. The polymer composition according to claim 35, wherein the polyether (ii-1) is obtainable from a triethylene glycol/pentaerythritol mixture with a molar ratio in the range from 1:10 to 10:1.

37. The polymer composition according to claim 28, comprising the polyether (ii-1) which has a number-average molar mass in the range from 100 g/mol to 50 000 g/mol.

38. The polymer composition according to claim 28, comprising the polycarbonate (ii-2) which is hyperbranched.

39. The polymer composition according to claim 28, comprising the polycarbonate (ii-2) which comprises no free OH groups.

40. The polymer composition according to claim 28, comprising the polycarbonate (ii-2) which has an average OH functionality of at least two.

41. The polymer composition according to claim 28, comprising the polycarbonate (ii-2) which has an OH number of from 2 to 800 mg KOH/g.

42. The polymer composition according to claim 28, comprising the polycarbonate (ii-2) which comprises propylene oxide units and/or comprises ethylene oxide units.

43. The polymer composition according to claim 28, wherein components (i) and (ii) are comprised in a mixture with one or more other flame-retardant compounds and/or with one or more synergists.

44. The polymer composition according to claim 43, wherein the synergist is comprised of organic peroxides, organic polysulfides, C—C-cleaving initiators, or elemental sulfur.

45. The polymer composition according to claim 43, wherein at least one sulfur compound of the formula (II) is comprised as the synergist,
A¹-(Z¹)-(S)ₙ-(Z²)ₚ-A² (II)
wherein
A¹ and A², being identical or different, are C₆-C₁₂-aryl, cyclohexyl, Si(OR^{a})₃, a saturated, to some extent unsaturated, or aromatic, mono- or bicyclic ring system which has from 3 to 12 ring members and which comprises one or more heteroatoms selected from the group consisting of N, O, and S, and which is unsubstituted or has substitution by one or more substituents selected from the group consisting of O, OH, S, SH, NH₂, COOR^{b}, CONR^{c}R^{d}, C₁-C₁₈-alkyl, C₁-C₁₈-alkoxy, C₁-C₁₈-thioalkyl, C₆-C₁₂-aryl, C₆-C₁₂-aryloxy, C₂-C₁₈-alkenyl, C₂-C₁₈-alkenoxy, C₂-C₁₈-alkynyl, and C₂-C₁₈-alkynoxy;
Z¹, and Z² being identical or different, are —CO— or —CS—;
R^{a} is C₁-C₁₈-alkyl;
R^{b}, R^{c}, and R^{d}, being identical or different, are H, C₁-C₁₈-alkyl, C₆-C₁₂-aryl or an aromatic, mono- or bicyclic ring system which has from 3 to 12 ring members and which comprises one or more heteroatoms selected from the group consisting of N, O, and S;
m and p, being identical or different, are 0 or 1, and
n is a natural number from 2 to 10,
and/or at least one sulfur compound of the formula (III) is comprised, 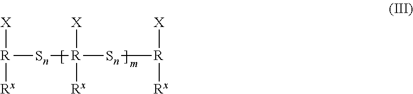
where the definitions of the symbols and indices are as follows:
R, being identical or different, is C₆-C₁₂-aryl, a 5-10-membered heteroaryl group which comprises one or more heteroatoms from the group of N, O, and S, C₁-C₁₆-alkyl, C₂-C₁₈-alkenyl, C₃-C₁₆-alkynyl, or C₃-C₁₀-cycloalkyl;
X, being identical or different, is OR^{y}, SW^{y}, NR^{Y}R^{Z}, COOR^{y}, CONR^{y}, SO₂R^{y}, F, Cl, Br, R, H, or a group —Y¹—P(Y²)ₚR′R″;
Y¹ is 0, S, or NR″′;
Y² IS 0 or S;
p is 0 or 1;
R′ and R″, being identical or different, are C₁-C₁₈-alkyl, C₂-C₁₈-alkenyl, C₃-C₁₈-alkynyl, C₆-C₁₂-aryl, C₃-C₁₀-cycloalkyl, C₆-0₁₂-aryl-C₁-C₁₈-alkyl, or a heteroaryl group or heteroaryloxy group which comprises one or more heteroatoms selected from the group consisting of N, O, and S, O—(C₁-C₁₈)-alkyl, O—(C₂-C₁₈)-alkenyl, O—(C₃-C₁₀)-alkynyl, O—(C₆-0₁₂)-aryl, O—(C₃-C₁₀)-cycloalkyl or O—(C₆-C₁₂)-aryl-(C₁-C₁₈)-alkyl;
R″′ is H, C₁-C₁₈-alkyl or (P(Y²)ₚR′R″);
R^{x}, being identical or different, is C₁-C₁₈-alkyl, C₂-C₁₀-alkenyl, C₃-C₁₀-alkynyl, C₆-C₁₂-aryl, C₃-C₁₀-cycloalkyl, C₆-C₁₂-aryl-C₁-C₁₈-alkyl, a heteroaryl group which comprises one or more heteroatoms selected from the group consisting of N, O, and S,
C₁-C₁₈-alkyl, C₂-C₁₆-alkenyl, C₃-C₁₈-alkynyl or C₃-C₁₀-cycloalkyl, O—(C₁-C₁₈)-alkenyl, O—(C₃-C₁₀)-alkynyl, O—(C₆-C₁₂)-aryl, O—(C₃-C₁₀)-cycloalkyl, O—(C₆-C₁₂)-aryl-(C₁-C₁₈)-alkyl, S—(C₁-C₁₈)-alkyl, S—(C₁-C₁₈)-alkenyl, S—(C₃-C₁₀)-alkynyl, S—(C₆-C₁₂)-aryl, S—(C₃-C₁₀)-cycloalkyl, (C₆-C₁₂)-aryl-(C₁-C₁₈)-alkyl-S, Fl, Cl, Br or H;
R^{y} and R^{z} being identical or different, are H, C₁-C₁₈-alkyl, C₂-C₁₈-alkenyl, C₃-C₁₈-alkynyl, C₆-C₁₂-aryl, C₃-C₁₀-cycloalkyl, C₆-C₁₂-aryl-C₁-C₁₈-alkyl, or a heteroaryl group which comprises one or more heteroatoms from the group of N, O, and S,
n is an integer from 1 to 8, and
m is a number from 1 to 1000.

46. The polymer composition according to claim 28, in the form of an expandable styrene polymer (EPS).

47. The polymer composition according to 28, in the form of an extruded styrene polymer foam (XPS).

48. A process for producing the expandable styrene polymer (EPS) according to claim 46, comprising the following steps:
a) mixing to incorporate an organic blowing agent and a flame retardant (ii) and optionally further auxiliaries and additives into a styrene polymer melt by means of static and/or dynamic mixers at a temperature of at least 150° C.,
b) cooling of the styrene polymer melt comprising blowing agent to a temperature of at least 120° C.,
c) discharging through a die plate with holes, the diameter of which at the die outlet is at most 1.5 mm, and
d) pelletizing the melt comprising blowing agent directly behind the die plate under water at a pressure in the range from 1 to 20 bar.

49. A process for producing the expandable styrene polymer according to claim 46, comprising the following steps:
a) polymerizing one or more styrene monomers in suspension;
b) adding a flame retardant (ii) and also optionally of her auxiliaries and additives prior to, during and/or after the polymerization reaction;
c) adding an organic blowing agent prior to, during, and/or after the polymerization reaction, and
d) isolating, from the suspension, the expandable styrene polymer particles comprising the flame retardant.

50. A process for producing the extruded styrene foam (XPS) according to claim 47, comprising the following steps:
a) heating a polymer component P which comprises at least one styrene polymer, to form a polymer melt,
b) introducing a blowing agent component T into the polymer melt to form a foamable melt,
c) extruding the foamable melt into a region of relatively low pressure with foaming to give an extruded foam, and
d) adding a flame retardant (ii) and also optionally of further auxiliaries and additives in at least one of steps a) and b).

51. An insulation material comprising the polymer composition according to claim 47.

52. An insulation material comprising the polymer composition according to claim 46 in expanded form.

53. A phosphorylated polyether (ii-1) with from 0.5 to 40% by weight phosphorus content, the main chain of which is formed exclusively from carbon atoms and from oxygen atoms, and which has at least three terminal and/or pendant OH groups, where these have been substituted to some extent or
entirely with at least one phosphorus-containing group (I), 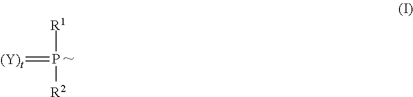
where the definitions of the symbols and indices are as follows:
˜ indicates the bond to the polymer skeleton of the polyether;
Y is 0 or S;
t is 0 or 1;
R¹ and R², being identical or different, are H, C₁-C₁₈-alkyl, C₂-C₁₈-alkenyl, C₂-C₁₈-alkynyl, C₃-C₁₀-cycloalkyl, C₆-C₁₀-aryl, furyl, C₆-C₁₀-aryl-C₁-C₁₀-alkyl, OR³, SR³, NR³R⁴, COR³, COORS or CONR³R⁴, or R¹ and R² form, together with the phosphorus atom P, a 4-8-membered ring system;
R³ and R⁴, being identical or different, are H, C₁-C₁₆-alkyl, C₂-C₁₆-alkenyl, C₃-C₁₆-alkynyl, C₃-C₁₀-cycloalkyl, C₆-C₁₀-aryl, furyl, C₆-C₁₀-aryl-C₁-0₁₀-alkyl and
wherein aryl groups in the moieties R¹, R², R³, and R⁴ are unsubstituted or have substitution by from 1 to 3 C₁-C₄-alkyl and/or C₁-C₄-alkoxy groups.

54. A process for producing the phosphorylated polyether (ii-1) according to claim 53, comprising reacting a polyether, the main chain of which is formed exclusively from carbon and oxygen atoms, and which comprises at least three terminal and/or pendant OH groups, with a phosphorus compound (I-A), 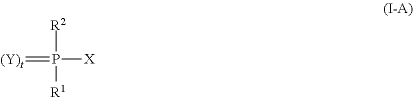
wherein X is Cl, Br, I, (C₁-C4)-alkoxy, or H, and the definitions of the remaining symbols are those stated in formula (I), so that the reaction product has from 0.5 to 40% by weight phosphorus content.

55. A flame retardant, comprising the phosphorylated polyether according to claim 52.
